(19) United States
(12) Patent Application Publication
(10) Pub. No.: US 2026/0257621 A1
(43) Pub. Date: Sep. 3, 2026

(54) TAIL LIGHT AND METHOD FOR THE OPERATION THEREOF, AND VEHICLE

(71) Applicant: MERCEDES-BENZ GROUP AG, Stuttgart (DE)

(72) Inventor: Carsten GUT, Korb (DE)

(21) Appl. No.: 19/489,962

(22) PCT Filed: Apr. 25, 2024
(86) PCT No.: PCT/EP2024/061422

§ 371 Date: Dec. 4, 2025

(30) Foreign Application Priority Data
Jun. 5, 2023 (DE) 10 2023 002 272.1

(51) Int. Cl. B60Q 11/00; B60Q 1/22; B60Q 1/30; B60Q 1/44; F21S 43/14; F21S 43/30; H05B 45/50

(52) U.S. Cl. CPC B60Q 11/007; B60Q 1/22; B60Q 1/30; B60Q 1/44; F21S 43/14; F21S 43/30; H05B 45/50

(57) ABSTRACT

A vehicle tail light includes a number of illuminants arranged one next to the other according to a pattern. At least one partner illuminant is allocated to each illuminant depending on a mirror symmetry or point symmetry in the pattern. A respective center point of a mirror axis or a mirror point lies in the geometric center point of the pattern. A respective partner illuminant is configured to be switched off when the illuminant to which the partner illuminant is allocated fails.

### BACKGROUND AND SUMMARY OF THE INVENTION

Exemplary embodiments of the invention relate to a tail light for a vehicle and a method for operating such a tail light and a vehicle having such a tail light.

Modern LEDs allow for the provision of particularly small yet bright illuminants. The resulting design freedom is used by vehicle manufacturers to specifically adjust the visual appearance of vehicles. Here, LEDs make it possible to provide not only point-like light sources on a vehicle, but also planar, strip-like, or matrix-shaped lighting.

For this purpose, several LEDs are arranged next to one another in specific patterns. Therefore, a plurality of individual illuminants is required to form such a light. LEDs are characterized by a long service life. However, it may be that individual LEDs fail prematurely. In such a case, the optical appearance of corresponding lights is adversely affected by the presence of dark areas. This can also impair the visibility of a corresponding vehicle in the dark.

This requires replacing the vehicle light, which comes with several disadvantages. Thus, the vehicle owner has to visit a repair shop, which involves effort. Additionally, the new light must be paid for, whereby costs emerge. The defective light must be disposed of, which pollutes the environment. In particular since a corresponding light still has functioning LEDs, solutions are being sought that make it possible to avoid replacing the entire vehicle light if individual LEDs fail.

DE 20 2010 004 874 U1 discloses an LED module with a passive LED. The printed publication describes an LED module consisting of several LEDs arranged on a circuit board. Each LED is coupled to a light coupling element of a light guide body to radiate the light emitted by the LEDs outwards. In addition to the LEDs, at least one passive LED is provided on the circuit board, the passive LED deactivated in a normal operating mode of the LED module and activated to act as a backup if at least one of the LEDs fails. By integrating additional LEDs, the LED module can be operated reliably even when individual LEDs fail. A disadvantage here, however, is the requirement to integrate additional LEDs into the LED module.

In addition, EP 1 000 806 B1 discloses a diagnostic system for an LED light in a motor vehicle. The LEDs of the LED light can be arranged in a matrix. The matrix can have several LED strings switched in parallel with one another, wherein several LEDs are switched in series in an LED string. If a single LED fails, then the entire LED string having the defective LED also fails.

Furthermore, DE 10 2022 115 153 A1 discloses a method and system for detecting LED failures in a vehicle lighting system. The vehicle lighting system comprises a first and a second light. If an LED in one of the two lights fails, then the two lights are deactivated.

In addition, DE 10 2018 201 102 A1 discloses a method and a device for functionally testing a matrix light source arrangement and a headlight therewith. To test the functionality of the light source arrangement, an energy value of one of two light sources of the light source arrangement is recorded and compared with a reference value.

In addition, DE 10 2012 003 200 B4 discloses a translucent body part for the outer skin of a motor vehicle. Functional lighting of the vehicle is here designed in two parts, wherein a first part uses a light source integrated into a headlight housing, and a second part uses the backlit, translucent body part. The translucent body part can extend across the entire width of the motor vehicle.

Furthermore, a lighting system for a vehicle is known from DE 10 2009 019 752 A1. The lighting system comprises a vehicle light with at least two LEDs. A control device is capable of establishing a failure of one of the LEDs and, depending on this, issuing a warning to a vehicle user.

Exemplary embodiments of the present invention are directed to an improved tail light for a vehicle and a method for the operation thereof, by means of which it is possible to further operate the tail light even in the event of failure of individual illuminants.

A generic tail light for a vehicle, comprising a plurality of illuminants arranged one next to the other according to a pattern, is developed according to the invention in that at least one partner illuminant is allocated to each illuminant depending on a mirror symmetry or point symmetry in the pattern, wherein a respective center point of a mirror axis or a mirror point lies in the geometric center point of the pattern, and wherein a respective partner illuminant is set up to be switched off when the illuminant to which the partner illuminant is allocated fails, such that the symmetry of the pattern is maintained.

If individual illuminants of a tail light fail, then this is noticed relatively quickly by an observer. Thus, a corresponding light characteristic emitted by the tail light has individual dark areas. The idea underlying the tail light according to the invention is to deactivate individual illuminants of the tail light from emitting light such that the symmetry of the pattern, in which the illuminants are arranged, is maintained. Thus, it is not immediately apparent that individual illuminants in the tail light have failed. Correspondingly, the tail light according to the invention can be further operated and does not need to be replaced.

Particularly preferably, the individual illuminants are here arranged in a two-dimensional field. Such a field can also be referred to as an array or matrix.

Allocating illuminants to partner illuminants is straightforward. Thus, the pattern in which the illuminants are arranged, i.e., the geometric distribution of the illuminants, is known. Correspondingly, depending on the respective symmetry, partner illuminants can be identified. The respective allocation can then be stored as digital data in a computer-readable storage medium of a processing unit. If at least one illuminant fails, then a corresponding control device for monitoring and/or controlling the illuminant accesses this data storage and can thus easily determine which partner illuminants must be switched off in general.

In this context, “switching off” means that if the respective illuminant fails, the partner illuminant is no longer controlled to emit light. The partner illuminant thus remains deactivated at all times. Here, the tail light can project static light characteristics or also dynamic light characteristics into the surroundings via the pattern.

An advantageous development of the tail light according to the invention provides that at least one illuminant is an LED. As already mentioned, LEDs can be produced with particularly small dimensions and high luminous efficacy, which allows for the creation of particularly elaborate patterns and thus visually appealing tail lights. LEDs are also comparatively inexpensive and are characterized by a long lifespan. In general, however, the illuminants could also be incandescent bulbs, xenon lamps, gas discharge lamps, lasers, and similar.

Corresponding to a further advantageous design of the tail light according to the invention, it has an integrated control unit for monitoring and/or controlling the illuminants. In order to ensure the operation of the tail light according to the invention, the individual illuminants must be monitored and controlled selectively. Here, both the monitoring and the control function can be integrated into a common control unit. The control unit can be part of the vehicle or, preferably, integrated into the tail light itself.

This makes it possible to provide a component that is easy to install and put into operation. However, the monitoring and control functionality can also be distributed across several computer systems or modules. For example, the monitoring functionality can be integrated into a computer system of the tail light and a control functionality into a control unit of the vehicle, or vice versa. However, both functionalities are particularly preferably provided by a control unit integrated into the respective tail light.

In particular, a respective control unit has a computer-readable storage medium in which the allocation of the illuminants to respective partner illuminants is stored.

A further advantageous design of the tail light according to the invention further provides that the pattern is designed in such a way that light with at least two different colors can be emitted by the illuminants at at least one location in the pattern and a corresponding partner location. In doing so, particularly elaborate light characteristics can be projected from the tail light into the surroundings. If the illuminants are arranged in a field, then “the location” can also be understood as a single pixel of the field or the matrix. Several differently colored illuminants can then be installed in such a pixel, or different colors can be emitted into the surroundings with one and the same illuminant. The partner location is determined analogously to the location of the partner illuminants for the respective illuminants. For example, the following three colors can be emitted into the surroundings at one and the same location: red, orange, and white, or red, green, and blue. Red is typically used by vehicles as a rear light or brake light. A turning indicator typically emits orange or yellow light. White light can be used to form a reversing light. For example, a red, green, and blue LED can be respectively provided at each location of the pattern, or in each pixel. By selectively controlling the brightness of the respective colored LEDs, a wide variety of colors can then be created by color addition, in particular red, orange, and white.

According to the invention, a method according to the invention for operating a tail light described above has the following method steps:
Monitoring the correct functionality of the illuminants; and after detecting a failure of at least one illuminant:
Deactivating the partner illuminant allocated to the failed illuminant for light emission.

Monitoring the correct functionality is possible with an internal or external monitoring unit with one of the respective tail lights. The monitoring unit can, for example, be part of the control unit or integrated into it. The respective partner illuminant can then be deactivated for emitting both static and dynamic illumination.

An advantageous development of the method provides that, to detect the failure of an illuminant, a monitoring module monitors an electrical voltage, an electrical current and/or a resistance of at least one part of an electrical circuit of the tail light. If a single illuminant in the tail light fails, then this affects the way in which electrical current flows through the circuitry of the tail light. Higher or lower voltages or currents can then flow between individual components. In particular, the resistance of individual components also changes. The monitoring module is capable of monitoring the respective components of the electrical circuitry of the tail light and thereby detecting failures of illuminants. Depending on which parts of the electrical circuitry change their behavior, the monitoring module is able to determine which illuminant has failed. Thus, for example, each illuminant is integrated into the electrical circuitry via an individual circuit. By analyzing which circuit changes its electrical behavior, the failed illuminant can then be determined.

The monitoring module can be the monitoring unit. The monitoring module can thus be integrated into the control unit or also be implemented externally. Similarly, the monitoring module can also be part of the tail light or also part of the vehicle.

A vehicle according to the invention has a tail light as described above. The tail light comprised by the vehicle is preferably operated using a method according to the invention. The vehicle can be any vehicle, such as a passenger car, truck, van, bus, a motorcycle, or similar, for example.

Here, an advantageous development of the vehicle provides that the tail light is configured to emit the light characteristics of a rear light, a reversing light, a brake light, and/or a turning indicator. According to the invention, the tail light is thus configured to function as a corresponding rear light, reversing light, brake light, and/or turning indicator. When operating as a rear light, moderately bright red light is projected statically into the surroundings. When functioning as a brake light, the red light projected into the surroundings is projected with a higher brightness into the surroundings upon actuating a brake pedal. When functioning as a reversing light, white light is projected into the surroundings after reverse gear is engaged. When functioning as a turning indicator, a corresponding orange or yellow flashing light is provided when an indicator lever in the vehicle is actuated.

For each function, an individual tail light can be provided on the vehicle, i.e., for example a tail light according to the invention to provide a reversing light and a tail light according to the invention as a brake light. Here, the respective tail lights can be provided in duplicate, once for the left half of the vehicle and once for the right half of the vehicle. However, a tail light in which all functions are integrated is particularly preferred.

Corresponding to a further advantageous design of the vehicle according to the invention, it has a continuous tail light extending horizontally across the rear of the vehicle, wherein the tail light is configured to emit a first light characteristic at least via a first part of the pattern and a light characteristic corresponding to the first light characteristic via a second part of the pattern. The first light characteristic can, for example, be the light characteristic of a brake light or a reversing light. The first part of the pattern can then, for example, be located in the region of the rear of the vehicle where the left brake lights or reversing lights are otherwise arranged. Correspondingly, the second part of the pattern can be located in the region of the rear of the vehicle where the right brake lights or reversing lights are otherwise arranged. The vehicle according to the invention thus preferably has a tail light according to the invention via which several light characteristics of different lighting functions can be provided. Here, for example, not only the left rear and right rear brake light can be provided, but also a third, additional brake light, for example, which, viewed in the direction of the vehicle transverse axis, is projected into the surroundings between the first part of the pattern and the second part of the pattern, in particular in the middle between the first part of the pattern and the second part of the pattern.

A further advantageous design of the vehicle according to the invention further provides that a monitoring module for detecting the failure of an illuminant is configured to issue the output of a warning message to a user via vehicle-internal output means after detecting the failure of at least one illuminant, wherein, in particular, the illuminants are divided into a first number of illuminants and a second number of illuminants depending on an arrangement in the pattern, and the monitoring module issues a different warning message when an illuminant of the first number fails to when an illuminant of the second number fails. A person driving the vehicle or the vehicle owner typically checks the correct functioning of their tail lights only irregularly or not at all. Correspondingly, it can happen that the corresponding person drives for a relatively long time with a defective tail light. According to the invention, however, the monitoring module can issue warning messages if at least one illuminant fails, such that the respective user can be made aware of the defect. Here, visual, acoustic, and/or haptic warning messages can be issued via corresponding output means. For example, explanatory text messages and/or pictograms can be issued on a display device in the vehicle, such as, for example, the instrument cluster, the head unit, a head-up display, or similar. Acoustic warning signals can be emitted via loudspeakers, such as, for example, the sound of a bell or siren, and/or corresponding text messages can be read aloud by a computer voice. In addition, structural parts of the vehicle frequently touched by vehicle occupants, such as the steering wheel, operating elements, the vehicle seat, pedals, or similar, can be set into vibration.

Corresponding notification messages can also be forwarded to a mobile device coupled to the vehicle, such as the smartphone of the user.

In the simplest case, the user is merely notified of the general failure of at least one illuminant. However, the notification message can be designed differently for different illuminants. This is the case, in particular, for a single tail light that extends across the entire width of the rear of the vehicle. For a vehicle to be road-worthy, it is required that specific lights are present in specific positions. For example, the brake light or reversing lights, turning indicators, and similar must be located in specific positions and here project very specific light characteristics into the surroundings. If such an illuminant fails, which specifically serves the function of the brake light, reversing light, turning indicator, or similar light, then the roadworthiness of the vehicle is adversely affected. In such a case, the notification message can include a request to find a repair shop in order to have the damage repaired as quickly as possible. In doing so, the vehicle remains roadworthy or is restored as quickly as possible. If, however, an illuminant fails that is does not serve to provide a corresponding light characteristic, then it is not necessarily required to find a workshop immediately. Correspondingly, the notification message can simply comprise that information that an illuminant has failed. Additionally, information can here be depicted specifying exactly which illuminant has failed. For example, an image of a tail light according to the invention can be depicted on a display device in the vehicle, wherein the failed illuminant is depicted highlighted.

Further advantageous designs of the tail light according to the invention, the method according to the invention for the operation thereof, and the vehicle according to the invention emerge from the exemplary embodiments, which are described in more detail below with reference to the figures.

### BRIEF DESCRIPTION OF THE DRAWING FIGURES

Here are shown in:

FIG. 1 a schematic view of the tail light according to the invention; and

FIG. 2 a schematic view of the rear of a vehicle according to the invention.

### DETAILED DESCRIPTION

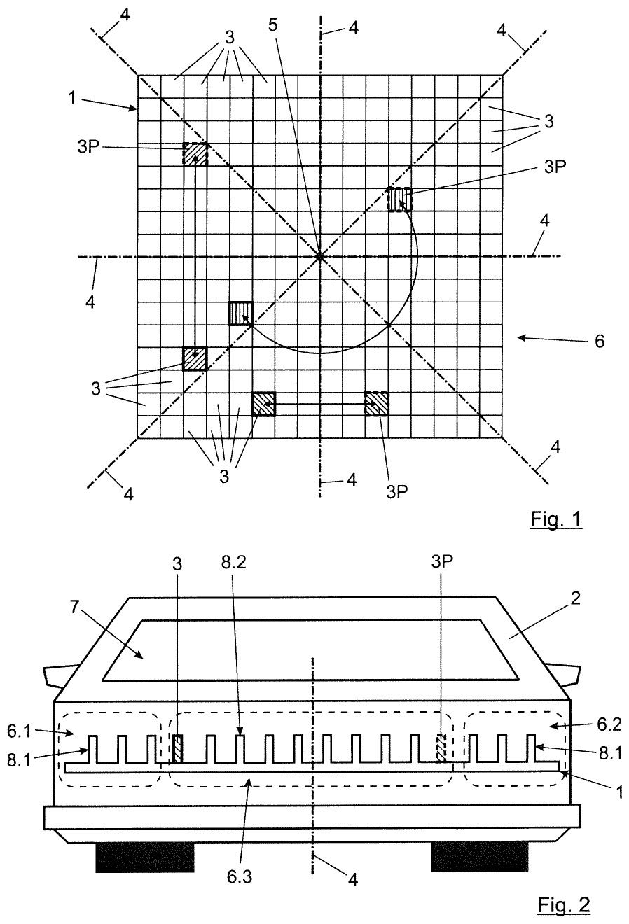

FIG. 1 shows a tail light 1 according to the invention for a vehicle 2 shown in FIG. 2. The tail light 1 comprises a plurality of illuminants 3 arranged according to a pattern 6. For preserving clarity, only some elements are here provided with a reference number. In the exemplary embodiment shown in FIG. 1, the illuminants 3, for example LEDs, are arranged in a square to form a field or a matrix. A respective position at which a respective illuminant 3 is arranged can then also be referred to as a pixel.

During operation of the tail light 1, it can occur that individual illuminants 3 fail. In FIG. 1, failed illuminants 3 are indicated by hatching. Those illuminants 3 that have failed are outlined with a thick, solid line.

As a result of the failure of individual illuminants 3, the optical appearance of the tail light 1 can be disadvantageously impeded. Correspondingly, a tail light 1 known from the prior art must be replaced. In order to prevent this according to the invention, there is an allocation of a respective illuminant 3 to corresponding partner illuminants 3P. The pattern 6 in which the illuminants 3 are arranged has at least one symmetry property. In FIG. 1, it is a square pattern, resulting in four axes of symmetry 4 and one point of symmetry 5. The respective partner illuminants 3P of the illuminants 3 are indicated by appropriate hatching and a dashed outline. Here, FIG. 1 shows the case where exactly one partner illuminant 3P is switched off for each illuminant 3. However, due to the symmetry of the pattern 6 depicted in FIG. 1, several partner illuminants 3P can be found for each illuminant 3, for example one partner illuminant 3P for the horizontal mirror axis 4 and one for the vertical mirror axis 4. Thus, it would be possible to switch off not only a single partner illuminant 3P for each illuminant 3, but several (not shown).

By switching off the respective partner illuminants 3P, the symmetry of the pattern 6 is maintained when emitting light, such that the tail light 1 is not perceived as defective. Thus, there is no need to replace the tail light 1. Thus, costs for the vehicle owner can be reduced and the environment is protected by reducing waste.

FIG. 2 shows the view of the vehicle rear 7 of a vehicle 2 according to the invention. The tail light 1 is here implemented horizontally across the entire rear 7 of the vehicle. Here, the pattern 6 can preferably be divided into at least one first part 6.1, a second part 6.2, and a third part 6.3. The light characteristic emitted by the illuminants 3 is preferably designed to be identical in the first part 6.1 and the second part 6.2 of the pattern 6. The design of the light characteristic in the third part 6.3 is initially irrelevant. Thus, it is possible to provide several different functional lighting functions, such as a turning indicator, a brake light, a reversing light, and similar, in the respective parts 6.1, 6.2, 6.3 via a single tail light 1. For example, the illuminants 3 can illuminate uniformly red across the entire pattern 6. If the vehicle 2 brakes, the brightness of the red light in the first part 6.1 and in the second part 6.2 can be increased such that a brake light can be displayed via this. Optionally, an additional brake light could be depicted in the third part 6.3 of the pattern 6.

Furthermore, notification messages can be issued to the person driving the vehicle of the vehicle 2 if at least one illuminant 3 fails. The illuminants 3 of the tail light 1 can be divided into a first number 8.1 and a second number 8.2. The division is carried out in particular depending on legal requirements. For example, certain functional lights must be provided in certain regions of the rear 7 of the vehicle, and corresponding light characteristics must be able to be generated. This is easily accomplished by means of the tail light 1 according to the invention. Thus, the illuminants 3 of the first number 8.1 serve, in particular, to form a brake light, reversing light, and/or turning indicator. By means of the illuminants 3 of the second number 8.2, then any light characteristic can then be projected into the surroundings, provided this complies with applicable law. If an illuminant 3 of the second number 8.2 fails, no further measures are initially required by the vehicle owner. If, however, an illuminant 3 of the first number 8.1 fails, then the tail light 1 may need to be repaired or replaced in order to maintain the roadworthiness of the vehicle 2. Correspondingly, if an illuminant 3 of the first number 8.1 fails, such notification messages can be issued to a user of the vehicle 2, that contain a request to visit to a workshop.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A vehicle tail light comprising:
a plurality of illuminants arranged one next to each other according to a pattern,
wherein at least one partner illuminant of the plurality of illuminants is allocated to each illuminant of the plurality of illuminants depending on a mirror symmetry or point symmetry in the pattern,
wherein a respective center point of a mirror axis or a mirror point lies in a geometric center point of the pattern, and
wherein a respective partner illuminant is configured to be switched off when the illuminant to which the partner illuminant is allocated fails to maintain symmetry of the pattern.

12. The vehicle tail light of claim 11, wherein at least of the plurality of illuminants is an LED.

13. The vehicle tail light of claim 11, further comprising:
an integrated control unit configured to monitor or control the plurality of illuminants.

14. The vehicle tail light of claim 11, wherein the pattern is designed in such a way that, for at least one location in the pattern and a corresponding partner location, light with at least two different colors are emittable by the plurality of illuminants.

15. A method for operating a vehicle tail light comprising a plurality of illuminants arranged one next to each other according to a pattern, wherein at least one partner illuminant of the plurality of illuminants is allocated to each illuminant of the plurality of illuminants depending on a mirror symmetry or point symmetry in the pattern, and wherein a respective center point of a mirror axis or a mirror point lies in a geometric center point of the pattern, the method comprising:
monitoring functionality of the plurality of illuminants; and
detecting failure of one of the plurality of illuminants and, responsive, deactivating light emission from a partner illuminant allocated to the one of the plurality of illuminants that failed.

16. The method of claim 15, wherein a monitoring module detects the failure of the one of the plurality of illuminants by monitoring an electrical voltage, an electrical current, or a resistance of at least one part of an electrical circuitry of the vehicle tail light.

17. A vehicle comprising:
a tail light, which comprises a plurality of illuminants arranged one next to each other according to a pattern,
wherein at least one partner illuminant of the plurality of illuminants is allocated to each illuminant of the plurality of illuminants depending on a mirror symmetry or point symmetry in the pattern,
wherein a respective center point of a mirror axis or a mirror point lies in a geometric center point of the pattern, and
wherein a respective partner illuminant is configured to be switched off when the illuminant to which the partner illuminant is allocated fails to maintain symmetry of the pattern.

18. The vehicle of claim 17, wherein the tail light is configured to emit a light characteristic of a rear light, a reversing light, a brake light, or a turning indicator.

19. The vehicle of claim 17, wherein the tail light is a continuous tail light extending horizontally across a rear of the vehicle, wherein the tail light is configured to emit a first light characteristic at least via a first part of the pattern and a light characteristic corresponding to the first light characteristic via a second part of the pattern.

20. The vehicle of claim 17, further comprising:
a monitoring module configured to detect failure of one of the plurality of illuminants, to issue a notification message to a user via vehicle-internal output after detecting the failure of at least one illuminant, wherein the plurality of illuminants are divided into a first number of illuminants and a second number of illuminants depending on an arrangement in the pattern, and the monitoring module issues a different notification message when an illuminant of the first number of illuminants fails to when an illuminant of the second number of illuminants fails.
